(19) United States
(12) Patent Application Publication
(10) Pub. No.: US 2013/0327910 A1
(43) Pub. Date: Dec. 12, 2013

(54) CHANNEL AND A CHANNEL ASSEMBLY INCORPORATING SAID CHANNEL

(71) Applicant: Matthew Freeman, Leeds (GB)

(72) Inventor: Matthew Freeman, Leeds (GB)

(73) Assignee: ACS STAINLESS STEEL FIXINGS LIMITED, Leeds (GB)

(21) Appl. No.: 13/884,455

(22) PCT Filed: Nov. 9, 2011
(86) PCT No.: PCT/GB2011/001567

§ 371 Date: Aug. 28, 2013

(30) Foreign Application Priority Data
Nov. 9, 2010 (GB) 1018910.8

(51) Int. Cl. F16M 13/02

(52) U.S. Cl. CPC F16M 13/02
USPC 248/231.91; 29/525.01

(57) ABSTRACT

A channel adapted to be attached to a building structure comprises a pair of lips defining a slot therebetween and a back portion having a rounded cross-sectional profile. Preferably, the back portion has an half-elliptical profile. This channel is adapted to form a channel assembly with a fixing co-operable therewith. In one embodiment, the fixing comprises a dome-shaped head constructed from a circular profile with flats on opposite sides thereof. Preferably, the dome-shaped head is made up of a series of radii that define part of an ellipse. Preferably also or in a another embodiment, the fixing comprises profiles that are stepped inwardly of opposite edges of the head between the flats. These profiles locate and bear against opposite edges of the lips when the head is rotated within the channel.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a channel that is adapted to be cast into or otherwise secured to a building structure and to a channel assembly incorporating said channel.

2. Description of Related Art Including Information Disclosed Under 37 CFR 1.97 and 37 CFR 1.98.

Such channels are primarily used in the building industry for fixing components to a building structure. Conventionally, a channel assembly comprises a channel and fixings or restraint ties that can be secured to the channel at any desired position along the length of the channel. The channel is adapted to be cast into a concrete face of a building during construction or is otherwise secured to a building structure, for example by bolts. The fixings or ties are then secured within the channel at appropriate positions and the former are used to secure ancillary components of the building structure, for example masonry support brackets, thereto. The channel offers continuous adjustment of the fixing or ties longitudinally and eliminates the need for the fixing or tie to be secured by drilling.

Channels with a rectangular cross-sectional profile have been used for many years for this purpose along with fixings in the form of T-headed bolts. The channel defines a slot between two lips on its outward facing side so that the head of the bolt can be inserted into the channel through the slot with its threaded tail projecting outwards. The bolt is then turned through 90° so that the bolt head abuts the inner sides of the lips. Typically, the head of the bolt is sized and shaped so that this operation locks the bolt in position with respect to the channel. When under tensile load, the channel then behaves as a beam between the bolts securing the bolts and thereby the components secured thereto to the building structure.

EP0882164 discloses a channel assembly wherein the channel has a substantially trapezoidal cross-sectional profile with side walls inclined towards a spine. The fixings for use with this channel have a head with inclined sides that has a generally elliptical cone shape. The effect of this is that on rotation of the head within the channel a camming action forces the head of the fixing against the lips of the channel and the sides of the head at its largest radius are forced against the side walls of the channel to lock the fixing in position. The inclined sides of the channel reduce the amount of metal required to form the channel for a given strength in beam action. The effect of this metal reduction is to give a more cost-effective channel for a given performance. However, in this assembly as the bolt is locked in position, the forces acting on the channel tend to pull open up the lips.

One object of the present invention is to provide a channel and thereby a channel assembly wherein the forces acting on the channel are better distributed in the channel so that the potential maximum capacity of the channel is increased without significantly increasing the amount of metal required to form the channel.

### BRIEF SUMMARY OF THE INVENTION

According to a first aspect of the present invention there is provided a channel adapted to be attached to a building structure comprising a pair of lips defining a slot therebetween and a back portion, characterized in that the back portion has a rounded cross-sectional profile.

The rounded cross-sectional profile of the back portion of the channel optimizes its capacity when the channel is cast into a concrete slab. As the back portion of the channel has no angles or creases, when the channel is under load the forces are distributed round the back portion and into the concrete surrounding it, thus reducing stress and deflection and increasing the potential maximum capacity of the channel.

Preferably, the back portion of the channel is formed by a continuous series of radiused sections.

Preferably also, the back portion of the channel has an half-elliptical profile.

Preferably also, outer surfaces of the lips are parallel to a minor axis of the half-elliptical profile defined by the back portion and wherein the back portion is bisected by a major axis of the half-elliptical profile defined by the back portion.

Preferably also, the widest interior dimension of the back portion of the channel is adjacent its joint with the lips of the channel.

In some embodiments the channel preferably comprises lips that are recurved inwardly of the channel.

Preferably also, the channel comprises one or more anchors fitted thereto at intervals along the length of the back portion. The anchors may be welded, swaged, pressed or otherwise secured to the channel.

According to a second aspect of the present invention there is provided a channel assembly adapted to be attached to a building structure comprising a channel according to the first aspect of the present invention and a fixing co-operable with the channel.

Preferably, the fixing comprises a head with flats on opposite sides thereof such that the head can pass between the lips and rotate through 90° within the channel to secure the fixing to the channel. Advantageously, the relative dimensions of the head of the fixing and the channel are such that rotation of the head through 90° within the channel locks the fixing in place with respect to the channel.

Preferably also, the back portion of the channel interacts with walls of the head on rotation of the head in the channel whereby the head is forced into contact with inner surfaces of the lips.

Preferably also, the head comprises profiles adjacent the flats that allow the head to rotate through 90° within the channel and that thereafter prevent further rotation in the same direction.

Preferably, the profiles are formed along opposite edges of the head between the flats and bear against the interior surface of the channel at locations where the back portion of the channel adjoin the lips. Alternatively or in addition the profiles are stepped inwardly of opposite edges of the head between the flats such that they locate and bear against opposite edges of the lips when the head is rotated within the channel. Preferably also, in the latter case the depth of the profiles is commensurate with the thickness of the lips in order that a flat base of the head lies flush with the outer surfaces of the lips.

Preferably also, each profile comprises a surface that adjoins the flats at one rounded or chamfered corner and at one right-angled corner, the two right-angled corners being diametrically opposed.

It will be appreciated that the channel and the fixing that make up the assembly are each capable of use independently with other types of fixings and channels respectively.

Hence, according to a third aspect of the present invention there is provided a fixing adapted to co-operate with an appropriately sized channel that comprises a pair of lips defining a slot therebetween, the fixing comprising a head with flats on opposite sides thereof and with profiles that are stepped inwardly of opposite edges of the head between the flats such that they locate and bear against opposite edges of the lips when the head is rotated within the channel.

Preferably, the profiles allow the head to rotate through 90° within the channel and thereafter prevent further rotation in the same direction.

Preferably also, the fixing comprises a bolt with a shank defining a shoulder on which the profiles are formed.

According to a fourth aspect of the present invention there is provided a fixing adapted to co-operate with an appropriately sized channel that comprises a pair of lips defining a slot therebetween, the fixing comprising a dome-shaped head constructed from a circular profile with flats on opposite sides thereof.

Preferably, the dome-shaped head is made up of a series of radii that define part of an ellipse.

Preferably also, additional material is provided on the head to form diagonally opposing right angled corners that, in use, serve to lock against the inner surface of the channel.

Preferably also, the additional material is blended smoothly into the part elliptical head so that the head retains a part elliptical profile when viewed from both end elevations.

In some embodiments the bolt preferably has a dome-shaped head. Preferably also, the dome-shaped head has a generally circular transverse cross-sectional profile. Preferably also, the dome-shaped head is formed by a continuous series of radiused sections, each with a generally circular transverse cross-sectional profile.

According to a fifth aspect of the present invention there is provided a method of securing a fixing in a channel, the method comprising the provision of a channel comprising a pair of lips defining a slot therebetween, the provision of a fixing comprising a head with flats on opposite sides thereof and with profiles adjacent the flats, the insertion of the head of the fixing into the channel and the rotation of head such that the profiles on the fixing locate and bear against opposite edges of the lips.

In all of the various aspects of the present invention, unless otherwise indicated the fixing may comprise either a bolt with a head and threaded tail or, alternatively, a nut with a threaded aperture in which can be screwed a threaded rod.

### BRIEF DESCRIPTION OF THE DRAWINGS

The various aspects of the present invention will now be described by way of example with reference to the accompanying drawings, in which:

FIG. 1 is a perspective view of a first embodiment of a channel according to the first aspect of the present invention;

FIG. 2 is a transverse cross-sectional view of a channel similar to that shown in FIG. 1 along with adjacent geometric figures showing how the channel's interior profile is derived therefrom;

FIG. 3 is a transverse cross-sectional view of a channel similar to that shown in FIG. 2 but manufactured by a different method;

FIGS. 4a and 4b are respectively a transverse cross-sectional view and a side view of a channel with an anchoring means for use in the securement of the channel to a building structure:

FIGS. 5a and 5b; 6a and 6b; and 7a and 7b are all pairs of views similar to FIGS. 4a and 4b but showing different configurations of anchoring means;

FIGS. 8a and 8b are perspective and plan views respectively of a first embodiment of fixing in accordance with the third aspect of the present invention that can be used to form a channel assembly with the channels shown in any of FIGS. 1 to 7b;

FIGS. 9a to 9c are plan, side and underneath views respectively of a second embodiment of fixing in accordance with the fourth aspect of the present invention that can be used to form a channel assembly with the channels shown in any of FIGS. 1 to 7b;

FIG. 9d is a view similar to FIG. 9b but from a side at 90° to the side shown in FIG. 9b;

FIGS. 9e and 9f are perspective views of the fixing shown in FIGS. 9a to 9d;

FIGS. 10a and 10b show respectively two stages in a method of forming a channel assembly according to the invention from the channel shown in FIG. 1 or FIG. 2 and the fixing shown in FIGS. 9a to 9f; and

FIGS. 11 to 18 are perspective views of eight embodiments of fixings that can be used to form a channel assembly in accordance with the second aspect of the present invention with any of the channels shown in FIGS. 1 to 7b.

### DETAILED DESCRIPTION OF THE INVENTION

Throughout this description, similar components or parts in the various embodiments and modifications are given the same reference numeral.

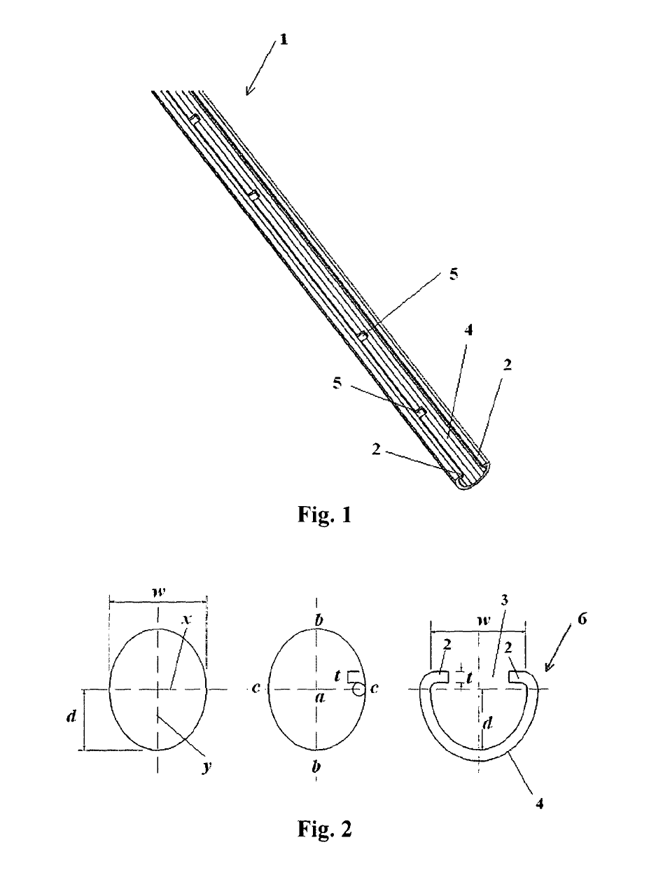

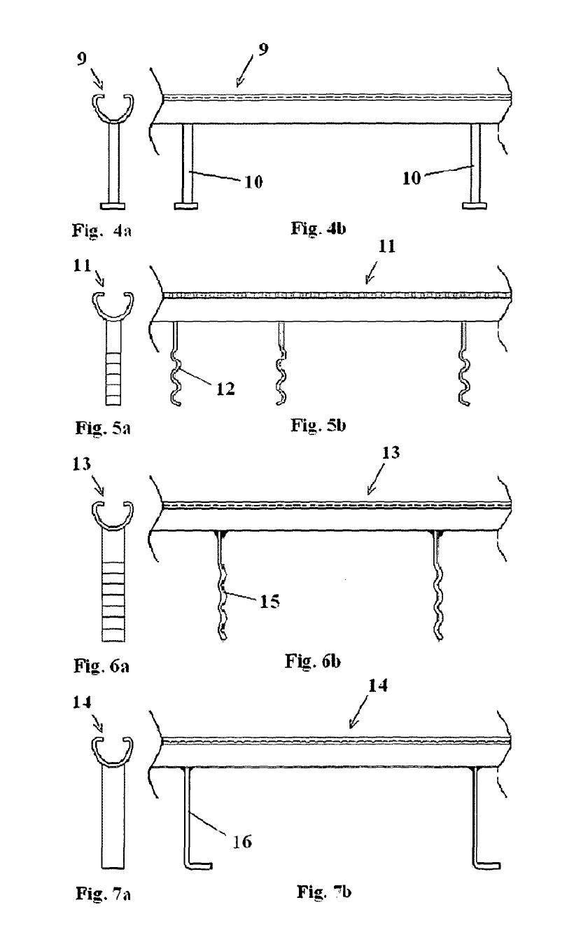

A first embodiment of channel 1 according to the invention is shown in FIG. 1 and has a generally D-shaped cross-sectional profile with a pair of lips 2 defining a slot 3 therebetween and a rounded back 4. In this embodiment apertures 5 are spaced along the length of the back 4 through which anchors (not shown) such as tangs, lugs or bolts can be fitted for the attachment of the channel 1 to a building structure. However, in other embodiments, apertures 5 need not be present as the anchors may be welded or otherwise secured to the channel 1, as described below with reference to FIGS. 4a and 4b, and FIGS. 5a to 7b.

The rounded back 4 of the channel 1 is formed by a continuous series of radiused sections and preferably has an half-elliptical profile. A similar channel 6 is shown in FIG. 2 but here the rounded back 4 of the channel is smooth and has an half-elliptical profile defined by half of an ellipse such that its minor axis x is parallel to the outer surfaces of the lips 2 and its major axis y bisects the rounded back 4. This means that the interior depth d of the channel 6 is commensurate with the major radius ab of the ellipse and, at its widest point, the interior width w of the channel 6 is commensurate with twice the minor radius ac of the ellipse. However, there is no fixed preferred ratio between the dimensions w and d when constructing the base shape for use in various iterations of the channel 1, 6. Notwithstanding this, such a rounded cross-sectional profile optimizes the capacity of the channel 1, 6 and means that that the widest interior dimension w of the channel is adjacent the joint of the back 4 with the lips 2. The channel 6 does not have apertures 5 as anchors can be attached thereto without apertures 5 being needed.

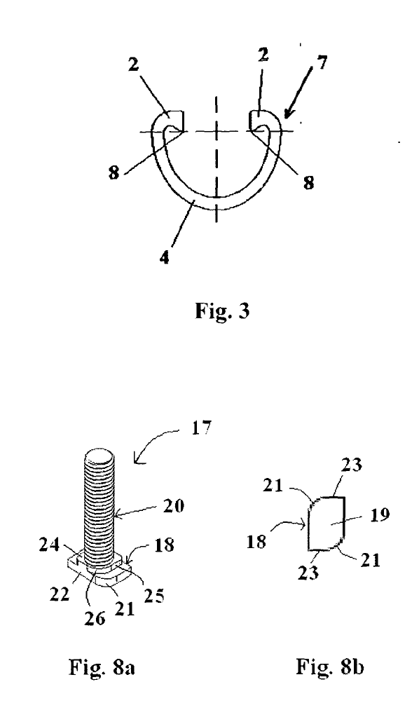

The material from which the channel 1, 6 is formed can be of any sheet thickness t depending on the loading and functional requirements of the channel 1, 6 when in use. FIGS. 1 and 2 show channels 1 and 6 that are manufactured by a cold rolling process. However, FIG. 3 shows a channel 7 manufactured by a hot rolling process, which is used to produce a channel when dynamic loading and higher load capacity are required. Such a channel 7 has lips 2 that are recurved inwardly of the channel 7 and that comprise tips 8 that hypothetically touch the minor axis of the ellipse defined by the interior profile of the back 4 of the channel 7.

FIGS. 4a and 4b show a channel 9 similar to the channels shown in FIGS. 1 to 3 but with one or more anchors 10 stud welded thereto at regular intervals along the length of the back 4. These anchors 10 are used to attach the channel 1 securely to a building structure. The anchors 10 have an enlarged head that is designed to be cast into the concrete of a building structure. The channel 11 shown in FIGS. 5a and 5b also has anchors 12 suitable for securement by being cast directly into a concrete building structure. These anchors pass through apertures in the channel 11 and are welded to the inside of the channel. The channels 13 and 14 shown in FIGS. 6a, 6b and FIGS. 7a, 7b respectively have welded-on anchors 15 and 16 respectively. Otherwise, the anchors 15 of the channel 13 are similar to the anchors 12 of channel 11 and the anchors 16 of the channel 14 are similar to the anchors 10 of the channel 9.

All of the channels described above are designed to form an assembly with one or more fixings that may take the form of a bolt or of a nut that is then secured to other ancillary components to be attached to the building structure by the channel assembly.

An embodiment of bolt 17 in accordance with a third aspect of the present invention and that forms an assembly with any of the channels shown in any of FIGS. 1 to 7b will now be described in more detail with reference to FIGS. 8a and 8b. In the following description the channel as shown in FIG. 1 is referred to but it will be appreciated that the bolt is capable of forming an assembly with any of the channels shown in FIGS. 1 to 7b in a similar fashion.

This bolt 17 is T-shaped and has a head 18 and a threaded tail 20. The head 18 has a flat top 19 and a substantially rectangular profile in plan, as shown in FIG. 8b, the width of the head being such that it will fit through the slot 3 with a small clearance. Two diagonally opposite corners 21 of the head are rounded so that the bolt 17 can be rotated through 90° when the head 18 has been inserted into a channel 1 such that it cannot then be extracted through the slot 3. Side walls 22 of the head 18 form flats on opposite side of the head 18 so that the head 18 can pass between the lips 2. Walls 23 at the ends of the head 18 are parallel to one another and normal to the top 19. These walls 23 interact or cam with the channel 1 upon rotation of the head 18 within the channel 1 so that the head 18 is forced forward in the channel into contact with the inner surfaces of the lips 2. In addition, when the bolt 17 has been turned through 90°, edges of the head 18 define profiles that engage the sides of the back 4 at the channel's widest point and retain the bolt 17 in position in the channel 1.

The shank of the bolt 17 is also provided with a shoulder 24 that is stepped inwardly of the ends of the head 18 between the flats. The shoulder 24 is profiled to define opposing flat sides 25 and two diagonally opposite rounded or chamfered corners 26 adjacent the similar corners 21 of the head 18. When the head 18 is inserted into the channel 1 and the bolt 17 is rotated the shoulder 24 locates between the lips 2 as the head 18 cams into position. The flat sides 25 are then brought into engagement with opposite edges of the lips 2 and act as a secondary lock for the bolt 17 in the channel 1. In addition, the shoulder 24 adds material to the bolt head 18 at the point of highest stress to increase the load capacity of the bolt 17. Preferably, the depth of the shoulder 24 is commensurate with the thickness t of the lips in order that a flat surface of the shoulder 24 lies flush with the outer surfaces of the lips.

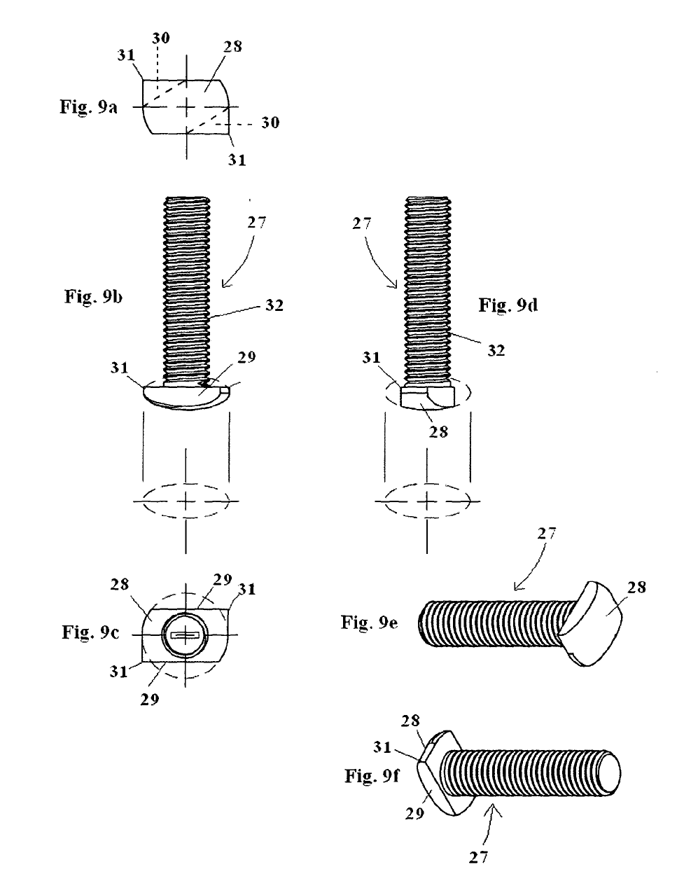

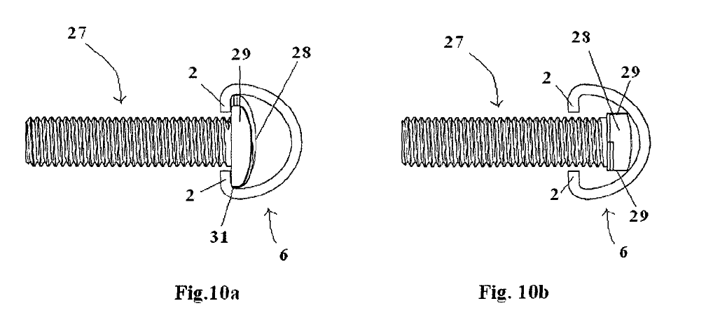

A second embodiment of bolt 27 in accordance with the fourth aspect of the present invention is shown in FIGS. 9a to 9f. This bolt 27 but has a dome-shaped head 28 constructed from a circular profile, as indicated in FIG. 9c, but with flats 29 on opposite sides thereof such that the head can pass between the lips 2 of the channel 1 or 6, as shown in FIG. 10a. The dome-shaped head 28 is made up of a series of radii that define part of an ellipse, as shown schematically in FIGS. 9b and 9d. This means that the head 28 will interact or cam with the channel 1, 6 upon rotation of the head 28 within the channel 6 so that the head 28 is forced forward in the channel 6 into contact with the inner surfaces of the lips 2, as shown in FIG. 10b. In order that the channel 6 can resist rotation beyond 90°, additional material 30 is provided to form diagonally opposing right angled corners 31 (see FIG. 9c) that serve to lock against the inner surface of the channel 6 and lock the bolt 27 into its final load-bearing position. This additional material 30 is blended smoothly into the part elliptical head 28 of the bolt 27, as shown by the parts labelled 30 within the dashed lines shown in FIG. 9a. This is so that there is no interference with the channel 6 as the head 28 is rotated and so that the head 28 still retains its part elliptical profile when viewed from both end elevations (see FIG. 9d).

In the illustrated embodiment, the shank 32 of the bolt 27 is not provided with a shoulder 24 similar to that described above but such a shoulder 24 could also be provided that would act in a similar fashion.

In a channel assembly according to the present invention, the round-backed channel 1 has benefits in both the stress and deflection and is mechanically stronger than conventional channels. Fixings such as the bolts 17 and 27 are equally as strong as conventional fixings. It will be appreciated that such a channel and fixings are each capable of use independently with other conventional types of fixings and channels respectively.

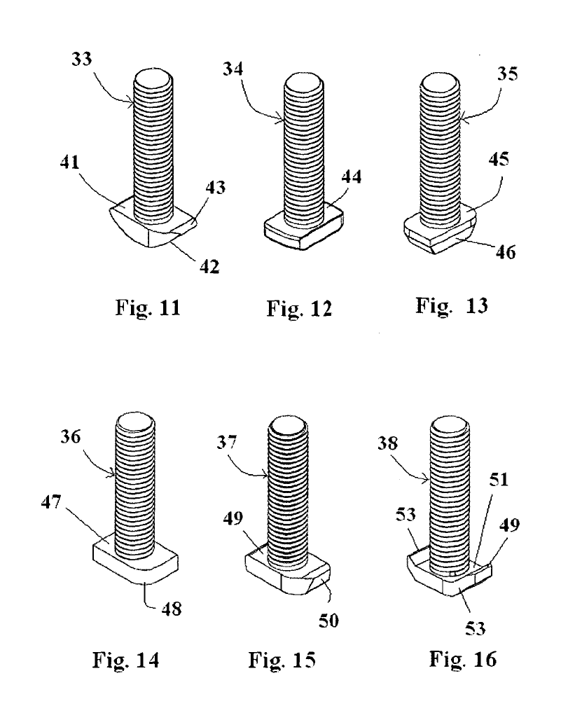

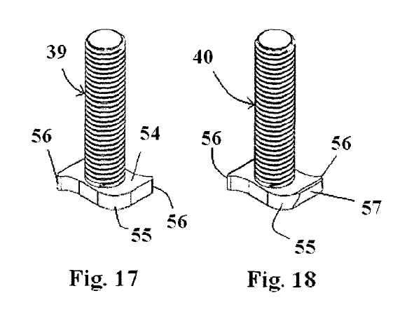

FIGS. 11 to 18 show eight further designs of T-shaped bolts that are numbered 33 to 40 respectively and that can each be used to form a channel assembly with a channel in accordance with the present invention. These bolts will now be briefly described. It will be seen that none of them is provided with a shoulder 24 as described above but it will be appreciated that all of them could be modified in this way if desired.

The bolt 33 has a head 41 with a generally rectangular profile and rounded sides made up of a part radius to allow the bolt 33 to be rotated in the channel 1 into a locked position at approximately 90° to the insertion angle. In a modification, the head 41 could be truncated on the radius and an angled chamfer used instead of the smaller radii to provide the same function. The head 41 is constructed with a rounded or chamfered part 42 with contact points 43 being of a smaller radius to allow the bolt 33 to fit into the channel 1 and contact the inner faces of the lips 2 upon rotation.

The bolt 34 has a head 44 with a generally elliptical profile with angled side portions.

Bolt 35 has a head 45 with a generally rectangular profile with rounded portions to allow the bolt to be rotated in the channel 1. The head also has tapered side walls 46 to allow it to be rotated in the channel 1 without clashing with the back part 4. Each of these tapered side walls 46 could also be constructed from a part radius in place of an angled side.

The bolt 36 is a plain T-headed bolt that is has a head 47 with a generally rectangular profile with rounded or angled edges 48 to allow it to be inserted into the channel 1 and rotated into its final position. The bolt 36 can be of any thickness that allows it to fit into the channel 1.

Bolt 37 is similar to the bolt 36 but its head 49 is modified by the addition of a radius or angle 50 on the ends of the head 49. These serve to allow a closer geometric fit with the inner profile of the channel 1 and allows the bolt 37 to be made thicker to increase its ultimate strength.

The bolt 38 has a head 51 with a rectangular profile with rounded or chamfered diagonally opposed corners 52 to allow it to be rotated in the channel 1 into a locked position. It can be see that the underside of the head 51 is provided with up-stand elements 53 that can be either radiused or angled forward to suit the shape of the channel. These up-stand elements 53 serve to lock the bolt 38 into the channel and prevent further rotation or loosening through vibration when used with a hot rolled or variation on the cold rolled version of the channel as shown in FIG. 3. The tips 8 of the lips 2 co-operate with the up-stand elements 53 and prevent small side-to-side movements of the bolt 38 in the channel when it is locked in position.

Bolt 39 has a head 54 with a substantially S-shaped profile, which is made up of a generally rectangular shape with rounded or chamfered diagonally opposing corners 55 and the addition of further material that form lateral projections 56 which ensure further rotation of the bolt 39, once rotated, is resisted.

Finally, the bolt 40 is similar in construction to the bolt 39 but with the addition of a radiused or angled edge 57. This feature provides a better geometric fit with the inner surface of the channel 1 and is inclined at substantially the same angle or radius as the inner face of the channel with which interacts to cam and lock the bolt into position.

1. A channel adapted to be attached to a building structure comprising a pair of lips defining a slot therebetween and a back portion, characterized in that the back portion has a rounded cross-sectional profile.

2. A channel as claimed in claim 1, wherein the back portion of the channel is formed by a continuous series of radiused sections.

3. A channel as claimed in claim 1, wherein the back portion of the channel has an half-elliptical profile.

4. A channel as claimed in claim 3, wherein outer surfaces of the lips are parallel to a minor axis of the half-elliptical profile defined by the back portion and wherein the back portion is bisected by a major axis of the half-elliptical profile defined by the back portion.

5. A channel as claimed in claim 1, wherein the widest interior dimension of the back portion of the channel is adjacent its joint with the lips of the channel.

6. A channel as claimed in claim 1, comprising lips that are recurved inwardly of the channel.

7. A channel as claimed in claim 1, comprising one or more anchors fitted thereto at intervals along the length of the back portion.

8. A channel as claimed in claim 7, wherein the anchor or anchors are welded to the channel.

9. A channel assembly adapted to be attached to a building structure comprising a channel as claimed in claim 1 and a fixing co-operable with the channel.

10. An assembly as claimed in claim 9, wherein the fixing comprises a head with flats on opposite sides thereof such that the head can pass between the lips and rotate through 90° within the channel to secure the fixing to the channel.

11. An assembly as claimed in claim 10, wherein the relative dimensions of the head of the fixing and the channel are such that rotation of the head through 90° within the channel locks the fixing in place with respect to the channel.

12. An assembly as claimed in claim 9, wherein the back portion of the channel interacts with walls of the head on rotation of the head in the channel whereby the head is forced into contact with the inner surfaces of the lips.

13. An assembly as claimed in claim 9, wherein the head comprises profiles adjacent the flats that allow the head to rotate through 90° within the channel and that thereafter prevent further rotation in the same direction.

14. An assembly as claimed in claim 13, wherein the profiles are formed along opposite edges of the head between the flats and bear against the interior surface of the channel at locations where the back portion of the channel adjoin the lips.

15. An assembly as claimed in claim 13, wherein the profiles are stepped inwardly of opposite edges of the head between the flats such that they locate and bear against opposite edges of the lips when the head is rotated within the channel.

16. An assembly as claimed in claim 15, wherein the depth of the profiles is commensurate with the thickness of the lips in order that a flat base of the head lies flush with the outer surfaces of the lips.

17. An assembly as claimed in claim 14, wherein each profile comprises a surface that adjoins the flats at one rounded or chamfered corner and at one right-angled corner, the two right-angled corners being diametrically opposed.

18. A fixing adapted to form part of a channel assembly as claimed in claim 9.

19. A fixing adapted to co-operate with an appropriately sized channel that comprises a pair of lips defining a slot therebetween, the fixing comprising a dome-shaped head constructed from a circular profile with flats on opposite sides thereof.

20. A fixing as claimed in claim 19, wherein the dome-shaped head is made up of a series of radii that define part of an ellipse.

21. A fixing as claimed in claim 19, wherein additional material is provided on the head to form diagonally opposing right angled corners that, in use, serve to lock against the inner surface of the channel.

22. A fixing as claimed in claim 21, wherein the additional material is blended smoothly into the part elliptical head so that the head retains a part elliptical profile when viewed from both end elevations.

23. A fixing adapted to co-operate with an appropriately sized channel that comprises a pair of lips defining a slot therebetween, the fixing comprising a head with flats on opposite sides thereof and with profiles that are stepped inwardly of opposite edges of the head between the flats such that they locate and bear against opposite edges of the lips when the head is rotated within the channel.

24. A fixing as claimed in claim 23, wherein the profiles allow the head to rotate through 90° within the channel and thereafter prevent further rotation in the same direction.

25. A fixing as claimed in claim 23, comprising a bolt with a shank defining a shoulder on which the profiles are formed.

26. A method of securing a fixing in a channel, the method comprising the provision of a channel comprising a pair of lips defining a slot therebetween, the provision of a fixing comprising a head with flats on opposite sides thereof and with profiles adjacent the flats, the insertion of the head of the fixing into the channel and the rotation of head such that the profiles on the fixing locate and bear against opposite edges of the lips.
